(19) United States
(12) Patent Application Publication
(10) Pub. No.: US 2026/0295794 A1
(43) Pub. Date: Oct. 1, 2026

(54) STAPLE-GUIDING UNIT AND STAPLE GUN HAVING THE SAME

(71) Applicant: PAO SHEN ENTERPRISES CO., LTD., Chang Hua (TW)

(72) Inventors: Sheng-Lung YEH, Chang Hua (TW); Chun-Man LAI, Chang Hua (TW)

(73) Assignee: PAO SHEN ENTERPRISES CO., LTD., Chang Hua (TW)

(21) Appl. No.: 19/268,055

(22) Filed: Jul. 14, 2025

(30) Foreign Application Priority Data
Apr. 1, 2025 (TW) 114112643

(51) Int. Cl. B25C 5/16; B25C 5/11

(52) U.S. Cl. CPC B25C 5/1644; B25C 5/11

(57) ABSTRACT

A staple-guiding unit includes a base plate and an extension member. The base plate includes a base wall, and a recess portion formed in the base wall and having a recess bottom surface. The base wall has rear and front side surfaces, and two abutment surfaces opposite to the rear side surface. Each abutment surface is spaced apart from the recess bottom surface along a front-rear direction by a first distance. The extension member is integrally formed with the base plate by an injection molding technique, and has first and second extension walls spaced apart from each other, and two extension wall surfaces respectively formed on sides of the first and second extension walls. Each extension wall surface is spaced apart from the recess bottom surface along the front-rear direction by a second distance, a ratio of the second distance to the first distance ranging from 8 to 4.

### CROSS-REFERENCE TO RELATED APPLICATION

This application claims priority to Taiwanese Invention Patent Application No. 114112643, filed on Apr. 1, 2025, the entire disclosure of which is incorporated by reference herein.

### FIELD

The disclosure relates to a staple gun, and more particularly to a staple-guiding unit for a staple gun and a staple gun having the same.

### BACKGROUND

Referring to FIGS. 1 and 2, Taiwanese Invention Patent Application Publication No. 202504731A discloses a conventional staple-guiding member and a conventional staple gun including the same. The staple gun includes a cover 100, a carrier 110 for carrying multiple staples 10, and a staple-guiding member 1. The cover 100 covers the staples 10 and has two guiding ribs 101 for guiding the staples 10 (only one is shown in FIG. 1 due to the viewing angle). The staple-guiding member 1 is integrally formed in one piece, and has a main body 11 having a three-step structure. The main body 11 has a first side surface 111, a second side surface 112 opposite to the first side surface 111, a first groove 113 recessed from the first side surface 111, and two second grooves 114 recessed from the first side surface 111 and respectively located on left and right sides of the first groove 113.

The staple-guiding member 1 is manufactured by stamping; specifically, a material of the main body 11 (e.g., metal) is put into a stamping machine and pressed to form a desired shape. Although the aforementioned metal stamping has the advantage of high production efficiency, the processing precision is limited by a die in the stamping machine. For example, as shown in FIG. 1, the second side surface 112 of the main body 11 protrudes or is recessed relative to the first side surface 111 (that is, when the first side surface 111 is recessed, the second side surface 112 protrudes, and vice versa), and thus the flatness of the second side surface 112 is poor.

In addition, as shown in FIG. 3, due to the limitations of stamping, a junction between each of the second grooves 114 and the first groove 113 is arc-shaped (e.g., rounded); specifically, the junction is not angled. Therefore, being placed in the second groove 114, one of the staples 10 is easy to move from the second groove 114 to the first groove 113 due to the inclination, so that the staple 10 cannot stably abut against the second groove 114, thereby affecting the stability of staple striking.

### SUMMARY

Therefore, an object of the disclosure is to provide a staple-guiding unit that can alleviate at least one of the drawbacks of the prior art.

According to the disclosure, the staple-guiding unit is adapted to be mounted to a case body unit of a staple gun, and includes a base plate and an extension member. The base plate includes a base wall that extends along an up-down direction, and a recess portion that is formed in the base wall. The base wall has a rear side surface that is flat, a front side surface that is opposite to the rear side surface, and two abutment surfaces that are opposite to the rear side surface. The recess portion is recessed from the front side surface, and has a recess bottom surface that is spaced apart from the two abutment surfaces along a front-rear direction transverse to the up-down direction, and two recess side surfaces that are respectively connected to two opposite sides of the recess bottom surface in a left-right direction transverse to the up-down direction and the front-rear direction. Each of the two recess side surfaces is connected to and is substantially transverse to a respective one of the two abutment surfaces so that a junction between each of the two recess side surfaces and the respective one of the two abutment surfaces is angled. Each of the two abutment surfaces is spaced apart from the recess bottom surface along the front-rear direction by a first distance. The extension member is integrally formed with the base plate by an injection molding technique. The extension member and the base plate cooperatively define a staple accommodation space. The extension member has a first extension wall and a second extension wall that are spaced apart from each other along the left-right direction and that extend from the front side surface in a direction away from the rear side surface, and two extension wall surfaces that are respectively formed on sides of the first extension wall and the second extension wall opposite to the base wall. Each of the two extension wall surfaces is spaced apart from a respective one of the two abutment surfaces along the front-rear direction, and is spaced apart from the recess bottom surface along the front-rear direction by a second distance, a ratio of the second distance to the first distance ranging from 8 to 4.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly exploded perspective view of a conventional staple gun including a staple-guiding member.

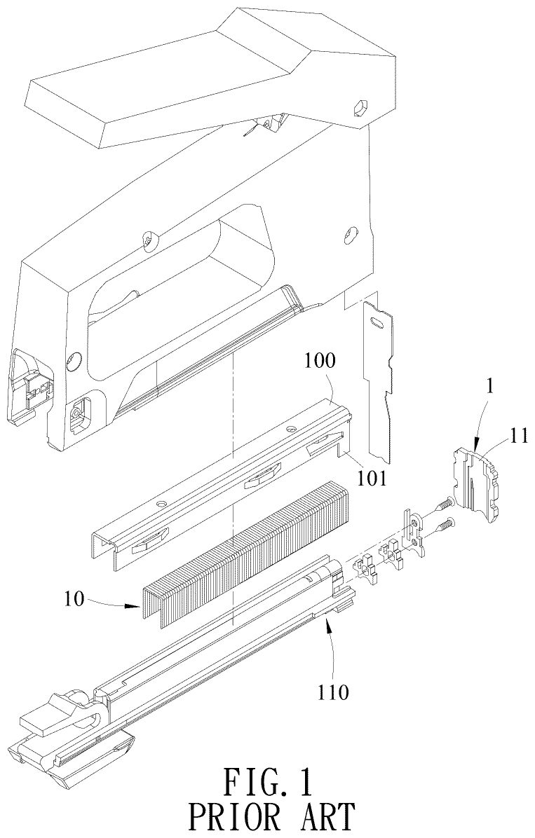

FIG. 2 is a perspective view of the staple-guiding member.

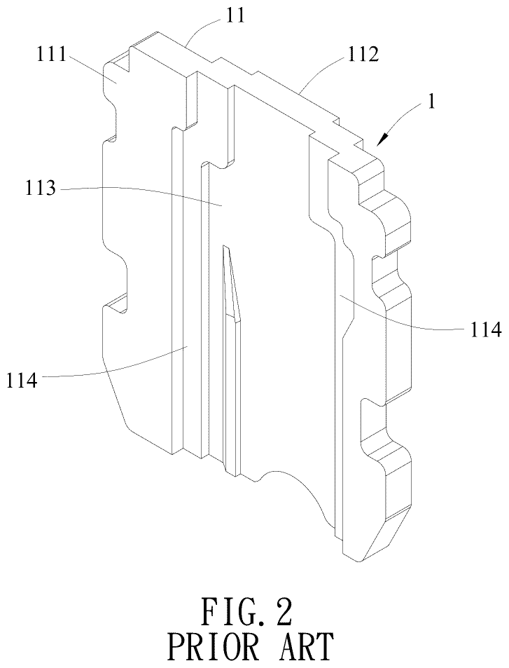

FIG. 3 is a schematic sectional view illustrating the staple-guiding member accommodating a staple.

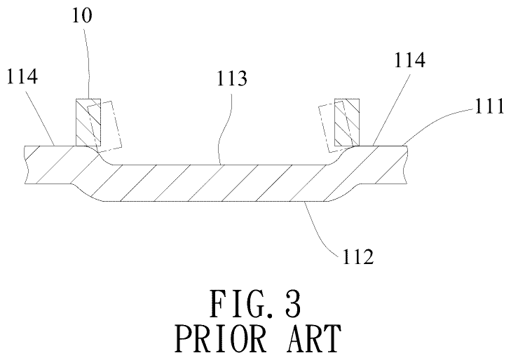

FIG. 4 is a partly exploded perspective view of an embodiment of a staple gun according to the disclosure.

FIG. 5 is a partly sectional view of the embodiment.

FIG. 6 is a fragmentary exploded perspective view of the embodiment.

FIG. 7 is a perspective view of a staple-guiding unit of the embodiment.

FIG. 8 is another perspective view of the staple-guiding unit.

FIG. 9 is a front view of the staple-guiding unit.

FIG. 10 is a sectional view taken along Line X-X in FIG. 9.

FIG. 11 is an enlarged view of the circled region XI in FIG. 10.

FIG. 12 is a fragmentary front view illustrating an assembly of the staple-guiding unit, a staple-guide seat and a staple-strike piece of the embodiment.

FIG. 13 is a schematic view illustrating a U-shaped staple with a rounded crown being disposed on the staple-guiding unit of the embodiment.

FIG. 14 is a schematic view illustrating a door-shaped staple with a flat crown being disposed on the staple-guiding unit of the embodiment.

FIG. 15 is a schematic view illustrating another door-shaped staple with a flat crown being disposed on the staple-guiding unit of the embodiment.

FIG. 16 is a schematic view illustrating yet another door-shaped staple with a flat crown being disposed on the staple-guiding unit of the embodiment.

FIG. 17 is a sectional view taken along Line XVII-XVII in FIG. 16.

FIG. 18 is an enlarged view of the circled region XVIII in FIG. 17.

FIG. 19 is a fragmentary exploded perspective view illustrating a T-shaped staple being disposed on another example of the staple-guiding unit of the embodiment.

FIG. 20 is a schematic view of the example of the staple-guiding unit in FIG. 19.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

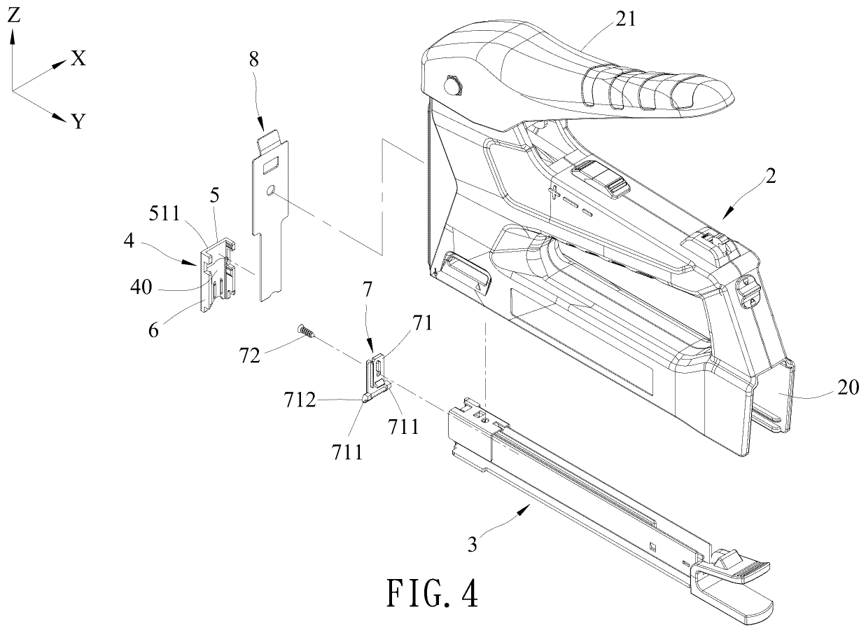

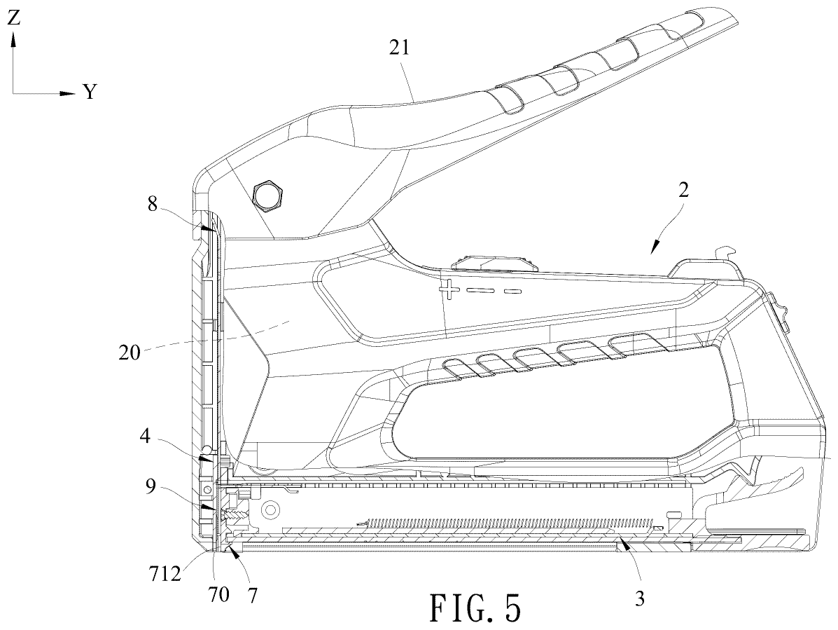

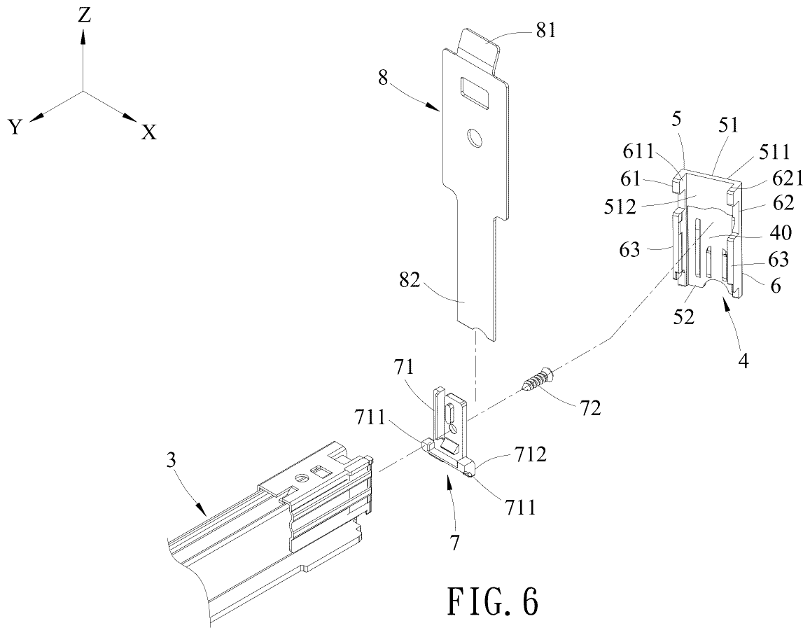

Referring to FIGS. 4 to 6, an embodiment of a staple gun according to the disclosure is adapted for accommodating multiple staples 9 (only one is shown in FIG. 5). The staples 9 come in various shapes, such as U-shaped staples with rounded crowns, door-shaped staples with flat crowns, T-shaped staples, etc. In some embodiments, for a single operation, a user may choose one type of the staples 9 to use with the staple gun according to actual need. The staple gun includes a case body unit 2, a carrier 3, a staple-guiding unit 4, a staple-guide seat 7, and a staple-strike piece 8.

The case body unit 2 defines a chamber 20, and includes a handle 21 that is operable and that is disposed on an upper end of the case body unit 2.

The carrier 3 is disposed in the chamber 20, extends in a front-rear direction (Y), and is adapted for the multiple staples 9 to be disposed thereon.

The staple-guiding unit 4 is mounted to the case body unit 2 and disposed in the chamber 20, and includes a base plate 5 and an extension member 6.

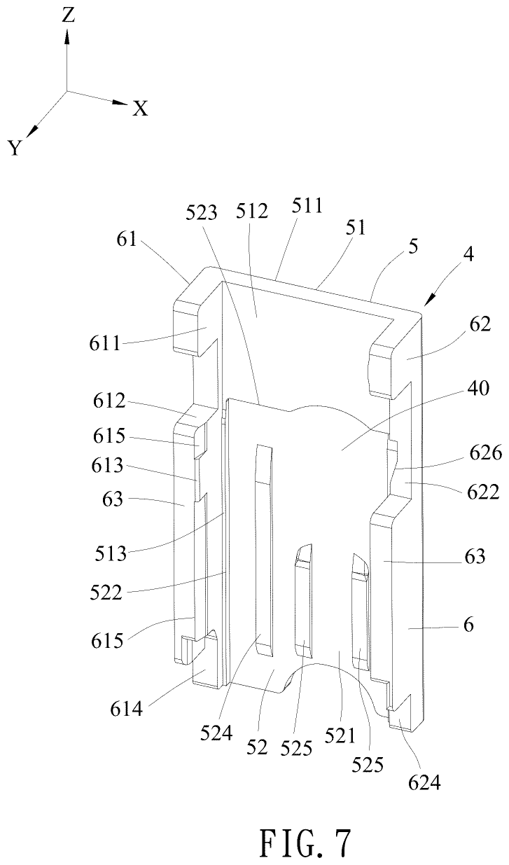

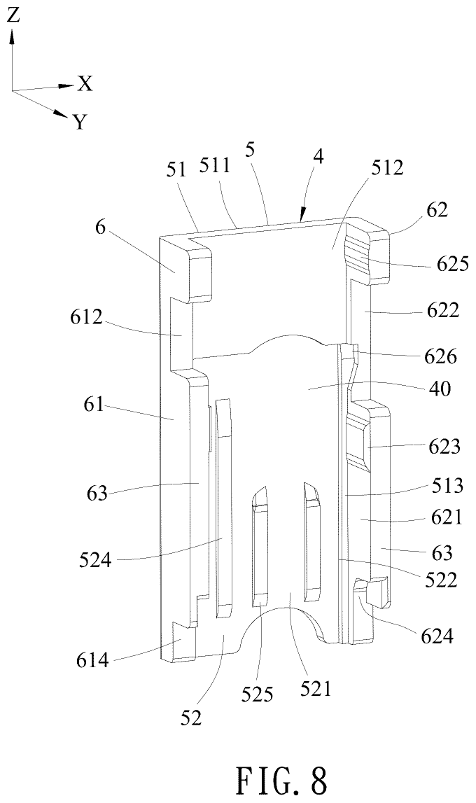

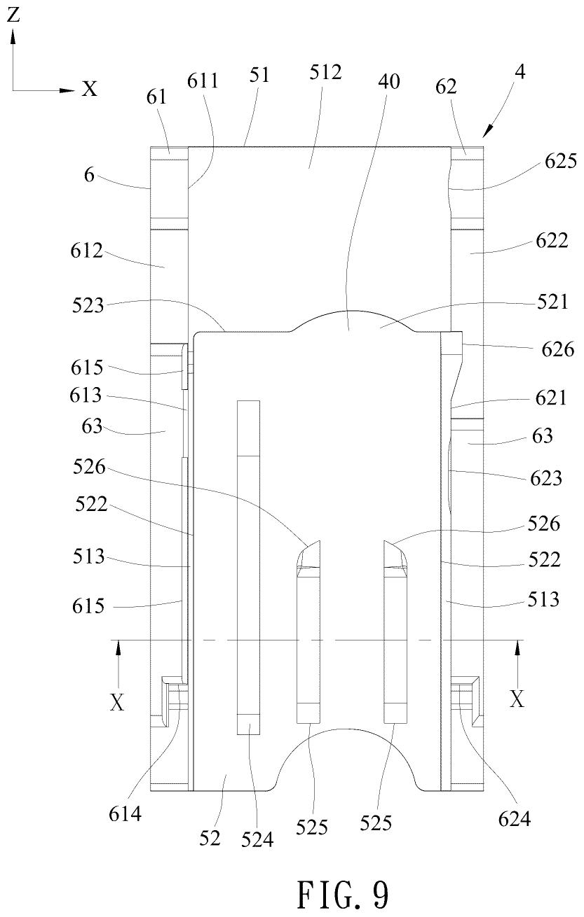

Referring to FIGS. 7 to 9, the base plate 5 includes a base wall 51 that extends along an up-down direction (Z) transverse to the front-rear direction (Y), and a recess portion 52 that is formed in the base wall 51. The base wall 51 has a rear side surface 511 that is flat, a front side surface 512 that is opposite to the rear side surface 511, and two abutment surfaces 513 that are opposite to the rear side surface 511 and that are spaced apart from each other in a left-right direction (X) transverse to the up-down direction (Z) and the front-rear direction (Y). The front side surface 512 faces the carrier 3.

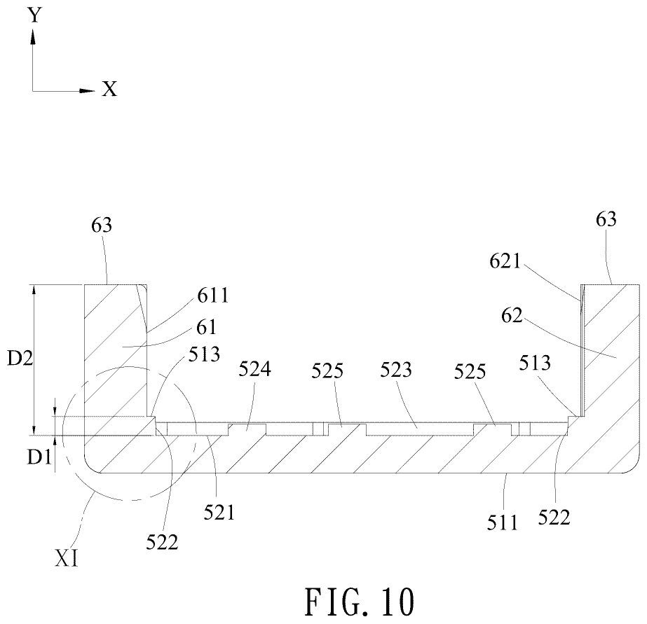

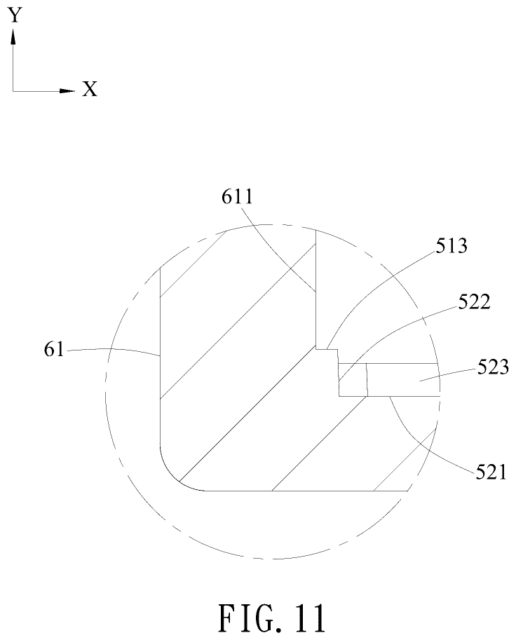

Referring to FIGS. 7, 8, 10, and 11, the recess portion 52 is recessed from the front side surface 512, and has a recess bottom surface 521 that is spaced apart from the two abutment surfaces 513 along the front-rear direction (Y), two recess side surfaces 522 that are respectively connected to two sides of the recess bottom surface 521 in the left-right direction (X), a recess upper surface 523 that extends in the left-right direction (X), and two opposite ends in the left-right direction (X) of which are respectively connected to the recess side surfaces 522, a first rib 524 that is elongated along the up-down direction (Z), and that protrudes from the recess bottom surface 521, and two second ribs 525 that are elongated along the up-down direction (Z), and that protrude from the recess bottom surface 521.

Each of the recess side surfaces 522 is connected to and substantially transverse to a respective one of the abutment surfaces 513, and is connected to and substantially transverse to the recess bottom surface 521. Specifically, two ends of each of the recess side surfaces 522 in the front-rear direction (Y) are respectively connected to and substantially transverse to the respective one of the abutment surfaces 513 and the recess bottom surface 521. A junction between each of the recess side surfaces 522 and the respective one of the abutment surfaces 513 is angled, and a junction between each of the recess side surfaces 522 and the recess bottom surface 521 is angled. Each of the abutment surfaces 513 is spaced apart from the recess bottom surface 521 along the front-rear direction (Y) by a first distance (D1). Each of the recess side surfaces 522 and the respective one of the abutment surfaces 513 define therebetween an angle ranging from 85° to 95°; in some embodiments, the angle is 90°, but is not limited thereto.

The angled junctions, formed by each of the recess side surfaces 522 being connected to and substantially transverse to the respective one of the abutment surfaces 513 and being connected to and substantially transverse to the recess bottom surface 521 through an injection molding technique, enable the abutment surfaces 513 to have sufficient abutting areas for the staple 9 (e.g., that is adjacent to the abutment surfaces 513 the most) to stably abut against the abutment surfaces 513 without deviation towards the recess bottom surface 521, which ensures the effect of stable striking.

Referring to FIGS. 7 to 9, the second ribs 525 are spaced apart from each other in the left-right direction (X), and are located at the same side of the first rib 524 in the left-right direction (X). In this embodiment, the first rib 524 and the second ribs 525 are protruding ribs. A length of each of the second ribs 525 along the up-down direction (Z) is less than a length of the first rib 524 along the up-down direction (Z). Each of the second ribs 525 has an oblique surface 526 that inclines downwardly and that is formed on an upper end of the second rib 525.

Referring to FIGS. 7, 8, 10, and 11, the extension member 6 is integrally formed with the base plate 5 by the injection molding technique. The extension member 6 and the base plate 5 cooperatively define a staple accommodation space 40 that spatially communicates with the recess portion 52, that faces the carrier 3, and that is adapted to accommodate the staples 9. The extension member 6 has a first extension wall 61 and a second extension wall 62 that are spaced apart from each other along the left-right direction (X) and that extend from the front side surface 512 in a direction away from the rear side surface 511, and two extension wall surfaces 63 that are respectively formed on sides of the first extension wall 61 and the second extension wall 62 opposite to the base wall 51. The first rib 524 is adjacent to the first extension wall 61 in the left-right direction (X); specifically, the first rib 524 is more adjacent to the first extension wall 61 than to the second extension wall 62.

Since the extension member 6 and the base plate 5 are integrally formed by the injection molding technique, the occurrence of deformation in the stamping process may be prevented, so that the rear side surface 511 of the base plate 5 does not protrude or is not recessed relative to the front side surface 512 (i.e., the configuration of the rear side surface 511 is not affected by the front side surface 512), and that the rear side surface 511 has better flatness and is more aesthetic.

The first extension wall 61 of the extension member 6 has a first inner surface 611 that faces the staple accommodation space 40, a first recess groove 612 that is recessed from the respective one of the extension wall surfaces 63 toward the rear side surface 511, a first protrusion block 613 that is adjacent to the respective one of the extension wall surfaces 63 and that protrudes toward the staple accommodation space 40, a first notch 614 that opens downward and that is spaced apart from the first recess groove 612 along the up-down direction (Z), and two trenches 615 that are respectively adjacent and connected to two sides of the first protrusion block 613 along the up-down direction (Z). In this embodiment, the first protrusion block 613 and the trenches 615 are formed in the first inner surface 611, and are spaced apart from the recess portion 52 in the front-rear direction (Y).

The second extension wall 62 of the extension member 6 has a second inner surface 621 that faces the staple accommodation space 40, a second recess groove 622 that is recessed from the respective one of the extension wall surfaces 63 toward the rear side surface 511, a second protrusion block 623 that protrudes toward the staple accommodation space 40 and that is adjacent to the recess portion 52, a second notch 624 that opens downward and that is spaced apart from the second recess groove 622 along the up-down direction (Z), a bump 625 that protrudes toward the staple accommodation space 40 and that is spaced apart from the recess portion 52 along the up-down direction (Z), and a ditch 626 that is formed in the second inner surface 621 and that opens toward staple accommodation space 40. A length of the second recess groove 622 along the up down direction (Z) is greater than a length of the first recess groove 612 along the up-down direction (Z). The second protrusion block 623 is not aligned with the first protrusion block 613 in the left-right direction (X). The second notch 624 corresponds in position to the first notch 614 in the left-right direction (X).

Each of the extension wall surfaces 63 is spaced apart from a respective one of the abutment surfaces 513 along the front-rear direction (Y), and is spaced apart from the recess bottom surface 521 along the front-rear direction (Y) by a second distance (D2), where D2:D1 ranges from 8:1 to 4:1, such as 6:1.

By means of the second distance (D2) being greater than the first distance (D1), compared to the prior art where the guiding ribs of the cover are used for guiding the staples, the first extension wall 61 and the second extension wall 62 of the embodiment may guide and thus position the staples 9, which saves the cost of an additional cover.

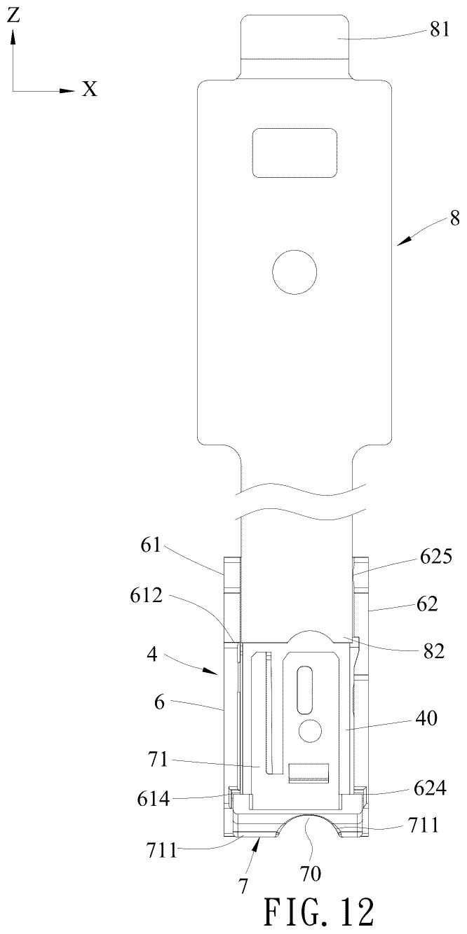

Referring to FIGS. 5, 6, and 12, the staple-guide seat 7 is disposed between the carrier 3 and the staple-guiding unit 4, and is connected to the carrier 3. The staple-guide seat 7 and the staple-guiding unit 4 cooperatively define a staple-strike opening 70 that spatially communicates with the staple accommodation space 40 and that opens downward. The first notch 614 spatially communicates with and is adjacent to the staple-strike opening 70, and the second notch 624 spatially communicates with and is adjacent to the staple-strike opening 70.

The staple-guide seat 7 has a seat body 71 that has two ends along the front-rear direction (Y) respectively facing the carrier 3 and the staple-guiding unit 4, and a fastener member 72 that connects the seat body 71 to the carrier 3. The seat body 71 has two staple-guide portions 711 that respectively engage the first notch 614 and the second notch 624, and each of the staple-guide portions 711 has a guide surface 712 that is adjacent to the staple-strike opening 70. The guide surfaces 712 face the staple-guiding unit 4 and are able to guide the staple 9 that is to be struck. The fastener member 72 is exemplified as a locking screw, but is not limited thereto.

The staple-strike piece 8 is disposed in the chamber 20, is movable along the up-down direction (Z), is located above the staple-strike opening 70 along the up-down direction (Z), and has an upper end 81 and a lower end 82 that is opposite to the upper end 81. The staple-strike piece 8 (specifically, the lower end 82) is adapted to strike one of the multiple staples 9 out of the staple-strike opening 70 when the staple gun is operated. In practice, the staple-strike piece 8 is urged by the handle 21 to strike one of the multiple staples 9 out of the staple-strike opening 70. Details regarding operation of the staple-strike piece 8 and the handle 21 is not further described herein, as those with ordinary skill in the art can figure the details out based on the aforesaid description.

Referring to FIGS. 5, 9 and 12, in this embodiment, the handle 21 is operated to urge the staple-strike piece 8 to move along the up-down direction (Z), so that the lower end 82 of the staple-strike piece 8 strikes the one of the multiple staples 9 out of the staple-strike opening 70. When the staple 9 that is adjacent to the abutment surfaces 513 the most (i.e., the one of the multiple staples 9) is struck out by the staple-strike piece 8, the remaining staples 9 move in sequence towards the recess portion 52. Through the configuration of the first protrusion block 613 of the first extension wall 61, the remaining staples 9 may be guided to a correct position. In addition, the bump 625 of the second extension wall 62 guides the staple-strike piece 8, so as to prevent the staple-strike piece 8 from deviating in the left-right direction (X).

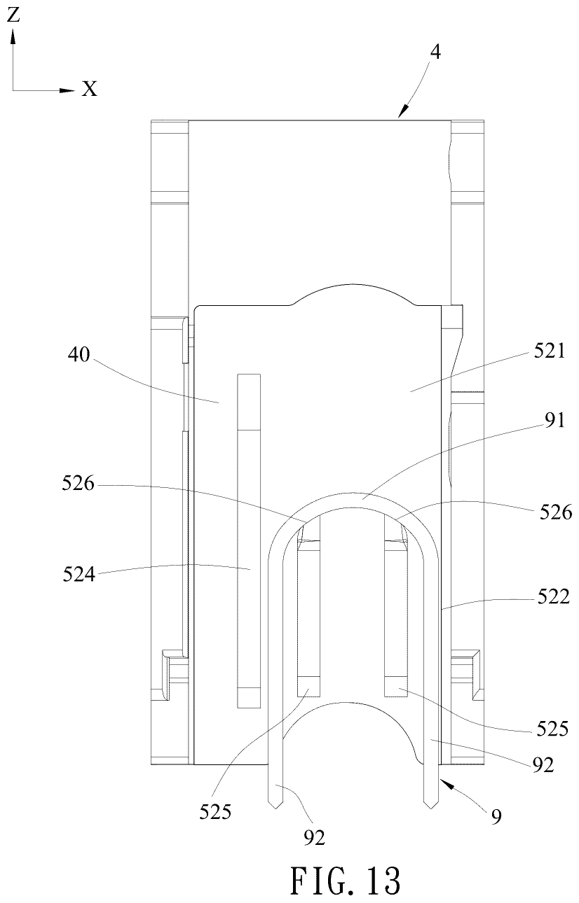

Referring to FIGS. 13 to 20, the positional relationships between different types of the staples 9 and the staple-guiding unit 4 will be described in sequence.

Referring to FIG. 13, the staple 9 is substantially U-shaped and includes a rounded crown 91 and two legs 92 that respectively extend downward from left and right ends of the rounded crown 91. In this example, the staple 9 contacts the recess bottom surface 521, a lower edge of the rounded crown 91 abuts against the oblique surfaces 526 of the second ribs 525, one of the legs 92 of the staple 9 is located between the first rib 524 and one of the second ribs 525, and the other one of the legs 92 of the staple 9 is located between the other one of the second ribs 525 and the recess side surface 522 at one side of the second ribs 525 opposite to the first rib 524.

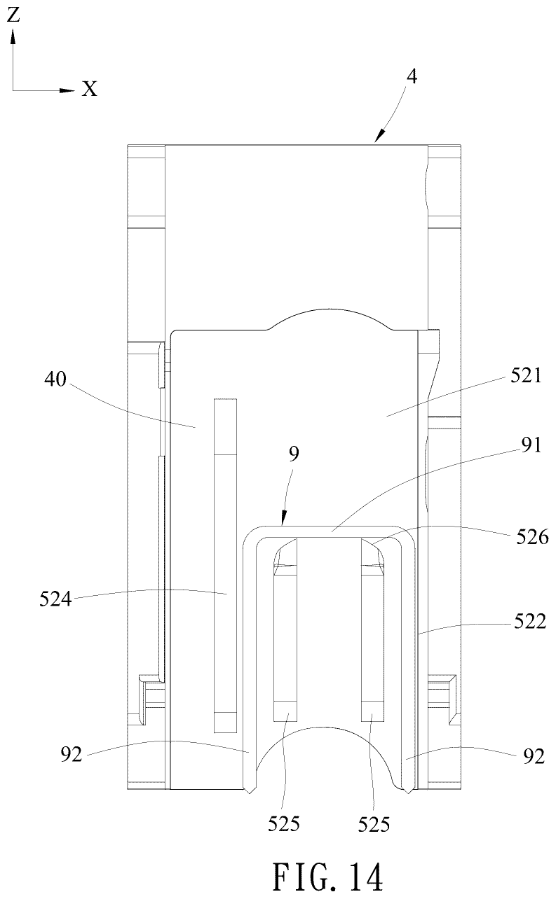

Referring to FIG. 14, the staple 9 is configured as a door-shaped staple, and includes a flat crown 91. In this example, the staple 9 contacts the recess bottom surface 521, a lower edge of the flat crown 91 abuts against top ends of the second ribs 525, one of the legs 92 of the staple 9 is located between the first rib 524 and one of the second ribs 525, and the other one of the legs 92 of the staple 9 is located between the other one of the second ribs 525 and the recess side surface 522 at one side of the second ribs 525 opposite to the first rib 524.

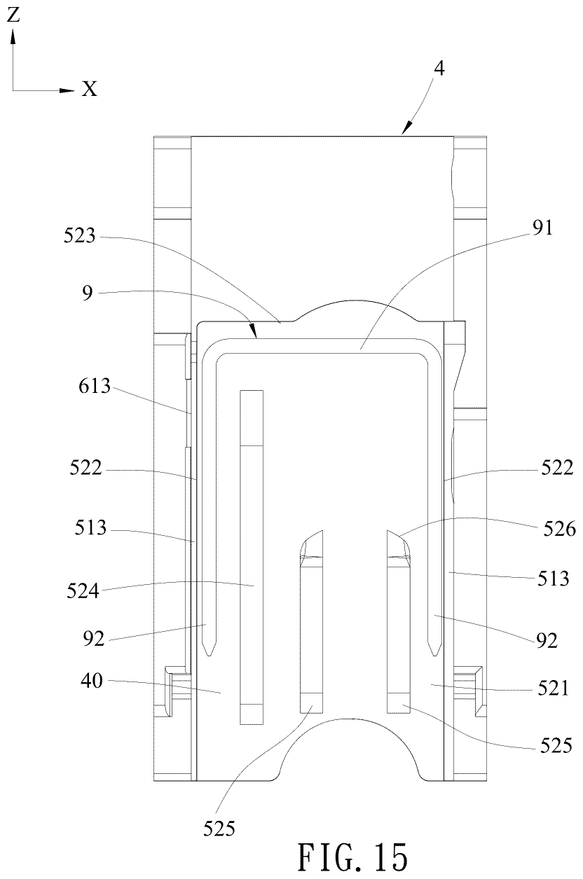

Referring to FIG. 15, the staple 9 is similar to the staple 9 in FIG. 14 but with a greater width in the left-right direction (X). In this example, the staple 9 contacts the recess bottom surface 521, the flat crown 91 is adjacent to the recess upper surface 523, one of the legs 92 of the staple 9 is located between the recess side surface 522 at one side of the first rib 524 opposite to the second ribs 525 and the first rib 524, and the other one of the legs 92 of the staple 9 is adjacent to the recess side surface 522 at one side of the second ribs 525 opposite to the first rib 524.

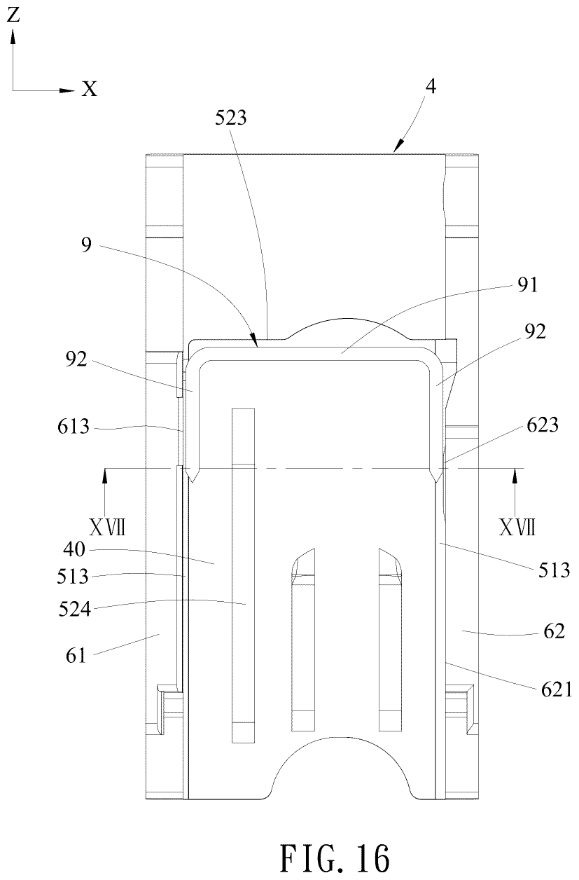

Referring to FIGS. 16, 17 and 18, the staple 9 is similar to the staple 9 in FIG. 15 but with an even greater width in the left-right direction (X) and a shorter length in the up-down direction (Z). In this example, the staple 9 is spaced apart from the recess bottom surface 521 in the front-rear direction (Y), the flat crown 91 is more adjacent to the recess upper surface 523, and the legs 92 respectively abut against the abutment surfaces 513 (specifically, the legs 92 are respectively adjacent to the first inner surface 611 and the second inner surface 621, and a lower end of one of the legs 92 abuts against the second protrusion block 623). The first protrusion block 613 of the first extension wall 61 guides the other one of the legs 92 and the second protrusion block 623 of the second extension wall 62 guides the one of the legs 92, thereby preventing the staple 9 from deviating in the left-right direction (X) when the staple 9 is being struck by the staple-strike piece 8, which leads to high operational stability.

Furthermore, for the staple in FIGS. 16 to 18, by virtue of the angled step formed by each of the recess side surfaces 522 and the respective one of the abutment surfaces 513, the legs 92 may stably and respectively abut against the abutment surfaces 513 without deviation towards the recess bottom surface 521, which ensures the effect of stable striking.

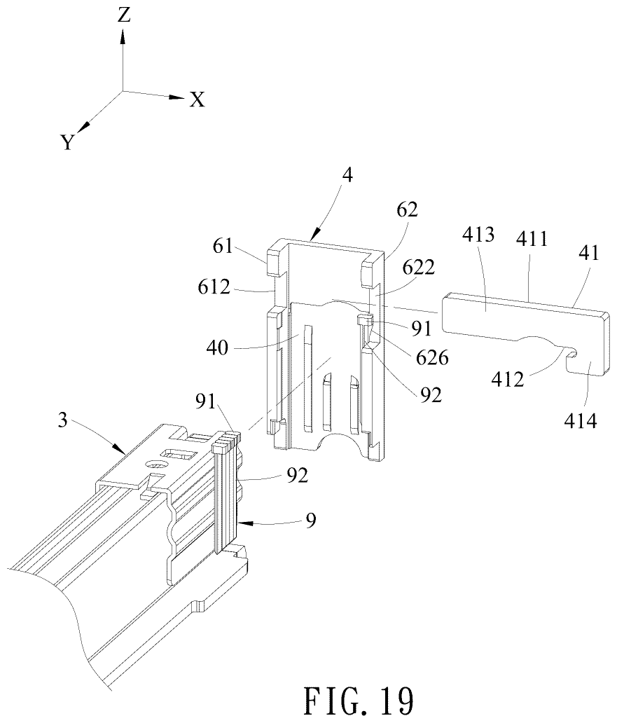

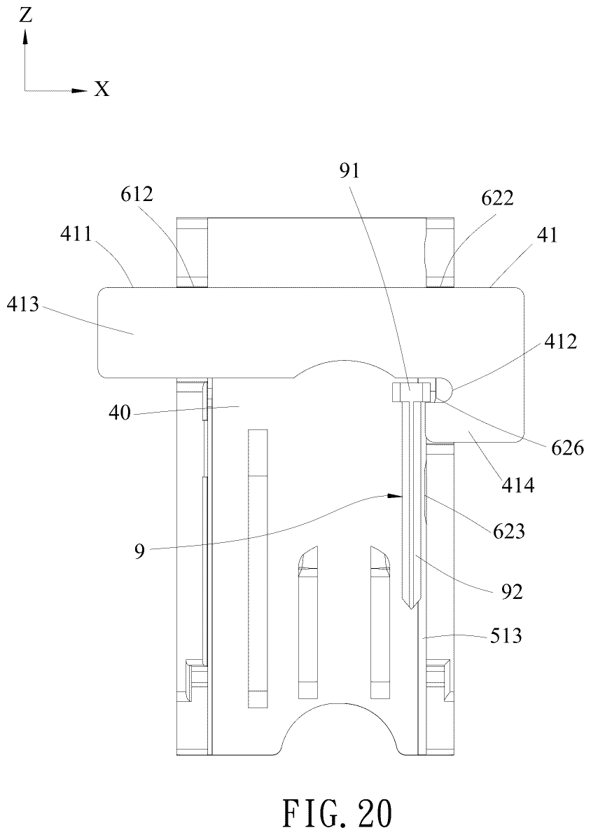

Referring to FIGS. 19 and 20, in a variant of the embodiment of the disclosure, the staple-guiding unit 4 further incudes an engagement plate 41 that is connected to the extension member 6. The engagement plate 41 has an engagement wall 411 that extends along the left-right direction (X) and that engages the first recess groove 612 and the second recess groove 622, and an engagement groove 412 that is formed in the engagement wall 411 and that opens toward the staple accommodation space 40. The engagement wall 411 has a first engagement segment 413 that extends out of the extension member 6 along the left-right direction (X), and a second engagement segment 414 that extends downward from one end of the first engagement segment 413 adjacent to the second extension wall 62. The engagement groove 412 is formed in the second engagement segment 414.

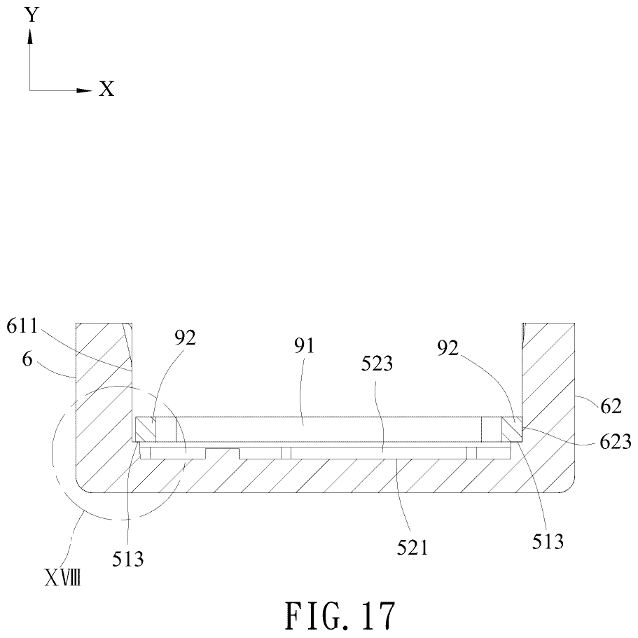

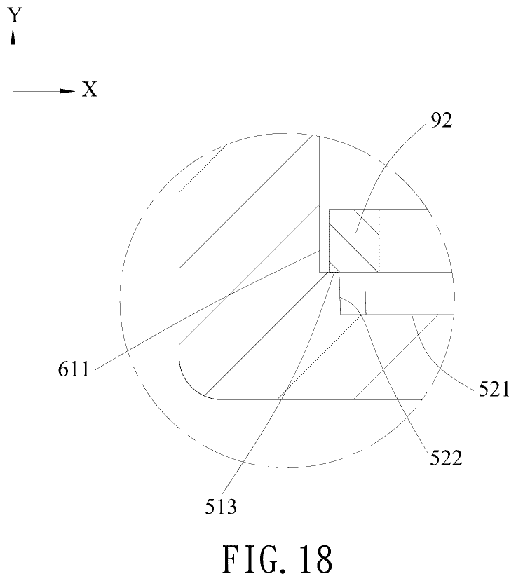

In an example where the staples 9 are T-shaped staples (see FIGS. 17 and 18), the crown 91 of the staple 9 that is adjacent to the right abutment surface 513 the most (hereinafter referred to as the first staple 9) is received by and abuts against the ditch 626, and the leg 91 of the first staple 9 abuts against one of the abutment surfaces 513 adjacent to the ditch 626. A bottom surface of the crown 91 of the staple 9 right after the first staple 9 (i.e., the bottom surface of the crown 91 of the next staple 9) abuts against the engagement groove 412, and bottom surfaces of the crowns 91 of the remaining staples 9 abut against the carrier 3. The second protrusion block 623 of the second extension wall 62 is operable to contact and thus guide the staples 9.

It should be noted that in other examples, the staples 9 in FIGS. 19 and 20 may omit the crowns 91; specifically, the staples 9 are I-shaped (not shown), and the leg 92 of the first staple 9 abuts against the right abutment surface 513, but is not limited thereto.

Advantages of the disclosure are listed as follows.

Since the extension member 6 and the base plate 5 are integrally formed by the injection molding technique, occurrence of deformation in the stamping process may be prevented, and thus the rear side surface 511 of the staple-guiding unit 4 has better flatness and is more aesthetic. Moreover, the angled step, integrally formed by each of the recess side surfaces 522 being connected to the respective one of the abutment surfaces 513 through the injection molding technique, enables the abutment surface(s) 513 to have sufficient abutting area(s) for the staple 9 to stably abut against the abutment surface(s) 513 without deviation towards the recess bottom surface 521, which ensures the effect of stable striking.

By means of the second distance (D2) being greater than the first distance (D1), compared to the prior art where the guiding ribs of the cover are used for guiding the staples, the first extension wall 61 and the second extension wall 62 of the embodiment may guide and thus position the staples 9, which saves the cost of an additional cover.

The first protrusion block 613 of the first extension wall 61 and the second protrusion block 623 of the second extension wall 62 may guide the leg(s) 92 of the staple 9, thereby preventing the staple 9 from deviating in the left-right direction (X) when the staple 9 is being struck by the staple-strike piece 8, which leads to high operational stability. Besides, the bump 625 of the second extension wall 62 guides the staple-strike piece 8 to prevent the staple-strike piece 8 from deviating in the left-right direction (X).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A staple-guiding unit adapted to be mounted to a case body unit of a staple gun, the staple-guiding unit comprising:
a base plate including a base wall that extends along an up-down direction, and a recess portion that is formed in said base wall, said base wall having a rear side surface that is flat, a front side surface that is opposite to said rear side surface, and two abutment surfaces that are opposite to said rear side surface, said recess portion being recessed from said front side surface, and having a recess bottom surface that is spaced apart from said two abutment surfaces along a front-rear direction transverse to the up-down direction, and two recess side surfaces that are respectively connected to two opposite sides of said recess bottom surface in a left-right direction transverse to the up-down direction and the front-rear direction, each of said two recess side surfaces being connected to and being substantially transverse to a respective one of said two abutment surfaces so that a junction between each of said two recess side surfaces and said respective one of said two abutment surfaces is angled, each of said two abutment surfaces being spaced apart from said recess bottom surface along the front-rear direction by a first distance; and
an extension member integrally formed with said base plate by an injection molding technique, said extension member and said base plate cooperatively defining a staple accommodation space, said extension member having a first extension wall and a second extension wall that are spaced apart from each other in the left-right direction and that extend from said front side surface in a direction away from said rear side surface, and two extension wall surfaces that are respectively formed on sides of said first extension wall and said second extension wall opposite to said base wall, each of said two extension wall surfaces being spaced apart from a respective one of said two abutment surfaces along the front-rear direction, and being spaced apart from said recess bottom surface along the front-rear direction by a second distance, a ratio of the second distance to the first distance ranging from 8 to 4.

2. The staple-guiding unit as claimed in claim 1, wherein said recess portion of said base plate further has a first rib that is elongated along the up-down direction, that protrudes from said recess bottom surface, and that is adjacent to said first extension wall in the left-right direction.

3. The staple-guiding unit as claimed in claim 2, wherein said recess portion of said base plate further has two second ribs that are elongated along the up-down direction, that protrude from said recess bottom surface, and that are spaced apart from each other in the left-right direction, a length of each of said two second ribs along the up-down direction being less than a length of said first rib along the up-down direction.

4. The staple-guiding unit as claimed in claim 1, wherein said first extension wall of said extension member has a first protrusion block that is adjacent to a respective one of said two extension wall surfaces and that protrudes toward said staple accommodation space.

5. The staple-guiding unit as claimed in claim 4, wherein said second extension wall of said extension member has a second protrusion block that protrudes toward said staple accommodation space and that is adjacent to said recess portion.

6. The staple-guiding unit as claimed in claim 1, further comprising an engagement plate, wherein:
said first extension wall has a first recess groove that is recessed from a respective one of said two extension wall surfaces toward said rear side surface, said second extension wall having a second recess groove that is recessed from the other one of said two extension wall surfaces toward said rear side surface; and
said engagement plate is connected to said extension member, and has an engagement wall that extends along the left-right direction and that engages said first recess groove and said second recess groove, and an engagement groove that is formed in said engagement wall and that opens toward said staple accommodation space.

7. The staple-guiding unit as claimed in claim 6, wherein a length of said second recess groove along the up-down direction is greater than a length of said first recess groove along the up-down direction.

8. The staple-guiding unit as claimed in claim 6, wherein said engagement wall has a first engagement segment that extends out of said extension member along the left-right direction, and a second engagement segment that extends downward from one end of said first engagement segment adjacent to said second extension wall, said engagement groove being formed in said second engagement segment.

9. The staple-guiding unit as claimed in claim 1, wherein said second extension wall has a bump that protrudes toward said staple accommodation space and that is spaced apart from said recess portion along the up-down direction.

10. The staple-guiding unit as claimed in claim 1, wherein each of said two recess side surfaces and said respective one of said two abutment surfaces define therebetween an angle ranging from 85° to 95°.

11. A staple gun adapted for accommodating multiple staples, the staple gun comprising:
a case body unit defining a chamber;
a carrier disposed in said chamber and adapted for the multiple staples to be disposed thereon;
a staple-guiding unit as claimed in claim 1, disposed in said chamber;
a staple-guide seat disposed between said carrier and said staple-guiding unit, and connected to said carrier, said staple-guide seat and said staple-guiding unit cooperatively defining a staple-strike opening that spatially communicates with said staple accommodation space of said staple-guiding unit and that opens downward; and
a staple-strike piece disposed in said chamber, movable along the up-down direction, located above said staple-strike opening along the up-down direction, and adapted to strike one of the multiple staples out of said staple-strike opening when said staple gun is operated.

12. The staple gun as claimed in claim 11, wherein:
said first extension wall of said extension member of said staple-guiding unit has a first notch that spatially communicates with said staple-strike opening, and said second extension wall of said extension member of said staple-guiding unit has a second notch that spatially communicates with said staple-strike opening and that corresponds in position to said first notch in the left-right direction; and
said staple-guide seat has two staple-guide portions that respectively engage said first notch and said second notch, and each of said two staple-guide portions has a guide surface that is adjacent to said staple-strike opening.
